(19) United States
(12) Patent Application Publication
(10) Pub. No.: US 2012/0284060 A1
(43) Pub. Date: Nov. 8, 2012

(54) SYSTEMS AND METHODS FOR PROCESSING INSURANCE INFORMATION

(75) Inventor: Alexey Saltykov, Toronto (CA)

(73) Assignee: INSUREYE INC., Toronto (CA)

(21) Appl. No.: 13/464,377

(22) Filed: May 4, 2012

Related U.S. Application Data
(60) Provisional application No. 61/483,384, filed on May 6, 2011.

(30) Foreign Application Priority Data
May 5, 2011 (CA) 2739211

(51) Int. Cl. G06Q 40/08

(52) U.S. Cl. 705/4

(57) ABSTRACT

Systems and methods for processing insurance information may comprise a memory and a processor. The memory may store asset and life situation data, life events data, and insurance data. The processor may be coupled to the memory and may be configured to determine asset and life situation events based on the asset and life situation data, determine insured events based on the insurance data, determine detailed coverage information by mapping the insured events to the asset and life situation events, and provide the detailed coverage information.

### CROSS-REFERENCE TO RELATED APPLICATIONS

This application claims priority from U.S. Provisional Patent Application No. 61/483,384, filed May 6, 2011 and Canadian Patent Application No. 2,739,211 filed May 5, 2011. The entirety of U.S. Provisional Patent Application No. 61/483,384 and Canadian Patent Application No. 2,739,211 are each hereby incorporated by reference.

### TECHNICAL FIELD

This specification relates to systems and methods for processing insurance information. In particular, the specification relates to an insurance information system that receives personal information from a user and insurance information from insurance policies and providers. The system uses the received information to generate detailed information about the user's insurance coverage across a variety of different insured assets and events. The system provides the insurance coverage details via a network to the user or to a third-party.

### BACKGROUND

The following paragraphs are not an admission that anything discussed in them is prior art or part of the knowledge of persons skilled in the art.

Insurance policies are a form of risk management used to hedge against the risk of possible loss. Personal insurance provides individuals with insurance coverage for particular assets/events and outcomes. Individuals usually exchange periodic monetary payments in exchange for a lump sum payment contingent on an outcome.

Insurance providers offer a wide range of insurable protection coverage, for example, home, auto, health, travel, life, disability, critical illness, liability, and credit coverage. Individual or business consumers are able to obtain an insurance policy over web-based user interfaces, over the phone, via mail, or in person.

Individuals may have over fifty different insurance products. Insurance policies may be complicated. For example, individuals may have difficulty understanding what assets/events are covered under a given insurance policy. Further, individuals may not understand completely the conditions of their policies. In certain situations, individuals may not know exactly what insurance coverage they own. An insurance agent, broker, or provider may be able to clarify some of the details, however, they may not have all of the insurance information available to make a fully informed account for the individual across all the policies.

### SUMMARY

In an aspect of this specification, a system for processing insurance information comprising a memory and a processor is provided. The memory may store asset and life situation data, life events data, and insurance data. The processor may be coupled to the memory and may be configured to determine asset and life situation events based on the asset and life situation data, determine insured events based on the insurance data, determine detailed coverage information by mapping the insured events to the asset and life situation events, and provide the detailed coverage information.

The embodiments described herein provide in one aspect, a system for processing insurance information, the system further comprising wherein the insurance data comprises personal and provider insurance data.

The embodiments described herein provide in one aspect, a system for processing insurance information, the system further comprising wherein the provider insurance data comprises data obtained from a plurality of distinct insurance providers.

The embodiments described herein provide in one aspect, a system for processing insurance information, the system further comprising wherein the processor receives asset, life situation, events, and personal insurance data from a user input device.

The embodiments described herein provide in one aspect, a system for processing insurance information, the system further comprising wherein the detailed coverage information is provided to a user device.

The embodiments described herein provide in one aspect, a system for processing insurance information, the system further comprising wherein the detailed coverage information comprises at least one of covered value, coverage condition, coverage price, and coverage name.

The embodiments described herein provide in one aspect, a system for processing insurance information, the system further comprising wherein the detailed coverage information further comprises at least one of: coverage overview, comparison information, coverage overlap information, coverage gap information, coverage terms information, coverage payment information, and coverage recommendation information.

The embodiments described herein provide in one aspect, a system for processing insurance information, the system further comprising wherein the processor is further configured for providing third parties a detailed overview of at least one of customer's assets, life situation, and insurance protection, and coverage.

The embodiments described herein provide in one aspect, a system for processing insurance information, the system further comprising wherein the third parties comprise at least one of brokers, agents, and insurance providers.

The embodiments described herein provide in one aspect, a method for processing insurance information, the method comprising: storing asset and life situation data, life events data, and insurance data in a memory; determining asset and life situation events based on the asset and life situation data using an at least one processor coupled to the memory; determining insured events based on the insurance data using the at least one processor; determining detailed coverage information by mapping the insured events to the asset and life situation events using the at least one processor; and providing the detailed coverage information.

The embodiments described herein provide in one aspect, a method for processing insurance information, the method further comprising wherein the insurance data comprises personal and provider insurance data.

The embodiments described herein provide in one aspect, a method for processing insurance information, the method further comprising wherein the provider insurance data comprises data obtained from a plurality of distinct insurance providers.

The embodiments described herein provide in one aspect, a method for processing insurance information, wherein the method further comprises receiving asset, life situation, events, and personal insurance data from a user input device.

The embodiments described herein provide in one aspect, a method for processing insurance information, the method further comprising wherein the detailed coverage information is provided to a user device.

The embodiments described herein provide in one aspect, a method for processing insurance information, the method further comprising wherein the detailed coverage information comprises at least one of covered value, coverage condition, coverage price, and coverage name.

The embodiments described herein provide in one aspect, a method for processing insurance information, the method further comprising wherein the detailed coverage information further comprises at least one of: coverage overview, comparison information, coverage overlap information, coverage gap information, coverage terms information, coverage payment information, and coverage recommendation information.

The embodiments described herein provide in one aspect, a method for processing insurance information, the method further comprising providing third parties a detailed overview of at least one of customer's assets, life situation, and insurance protection, and coverage.

The embodiments described herein provide in one aspect, a method for processing insurance information, the method further comprising wherein third parties comprise at least one of brokers, agents, and insurance providers

The embodiments described herein provide in one aspect, a non-transitory computer readable medium upon which a plurality of instructions is stored, for performing a method for processing insurance information.

Other aspects and features of the teachings disclosed herein will become apparent, to those ordinarily skilled in the art, upon review of the following description of the specific examples of the specification.

### BRIEF DESCRIPTION OF THE DRAWINGS

For a better understanding of embodiments of the systems and methods described herein, and to show more clearly how they may be carried into effect, reference will be made, by way of example, to the accompanying drawings in which:

FIG. 1 is a block diagram of an insurance information network system in accordance with at least one embodiment;

FIG. 2 is a block diagram and flow chart of the insurance information system of the insurance information network system of FIG. 1 in accordance with at least one embodiment;

FIG. 3 is a block diagram and flow chart of a database of insurance information in accordance with at least one embodiment;

FIG. 4 is a flowchart of a method for processing insurance information in accordance with at least one embodiment;

FIGS. 5A, 5B, 5C, 5D, and 5E are user interface displays to illustrate a method for receiving asset, life situation, and personal insurance data in accordance with at least one embodiment;

FIG. 6 is a sample list of life situation events in accordance with at least one embodiment;

FIG. 7 is a user interface display of insured events in accordance with at least one embodiment;

FIG. 8 is a user interface display of insured events, which are associated with asset and life situation events in accordance with at least one embodiment;

FIG. 9 is a user interface display of detailed coverage information for specific asset in accordance with at least one embodiment;

FIG. 10 is a flow chart of a method for mapping insured events to asset and life situation events in accordance with at least one embodiment.

FIG. 11 is a user interface display of detailed coverage information, which is associated with asset and life situation event, in accordance with at least one embodiment;

FIG. 12 is a user interface display of detailed coverage information, which is associated with planned life situation event, in accordance with at least one embodiment;

FIG. 13 is a user interface display of coverage payment information in accordance with at least one embodiment;

FIG. 14 is a user interface display of coverage overlap information in accordance with at least one embodiment;

FIG. 15A is a user interface display of an insurance calendar in accordance with at least one embodiment;

FIG. 15B is a user interface display of insurance tasks in accordance with at least one embodiment; and

FIGS. 16A and 16B are user interface displays of a detailed overview for a third party in accordance with at least one embodiment.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

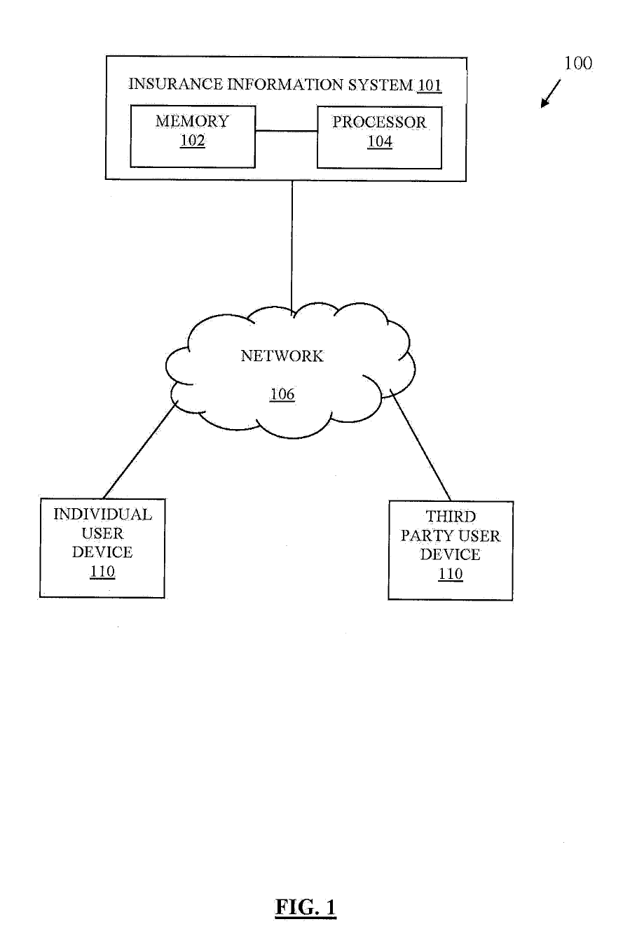

Reference is now made to FIG. 1, in which an insurance information network system 100 in accordance with an embodiment is illustrated. Insurance information network system 100 includes user devices 110. User devices 110 are connected to an insurance information system 101 via a network 106. Insurance information system 101 comprises a memory 102 and a processor 104.

Insurance information system 101 may be implemented using, for example, a general-purpose computer capable of responding to and executing instructions in a defined manner, a personal computer, a special purpose computer, a workstation, a server, a device, a component, or other equipment or some combination thereof capable of responding to and executing instructions. While insurance information system 101 is described as comprising memory 102 and processor 104 it will be understood by those skilled in the art that the insurance information system 101 may comprise any number of memories and processors to implement the system.

User device 110 may be operated by, for example, an individual user. User device 110 may be operated by, for example, a third party user. User device 110 may be operated by, for example, another type of user.

In at least one embodiment, users access insurance information system 101 via network 106 through a secure user interface. For example, users are required to log in or register to access insurance information system 101.

It will be appreciated that insurance information network system 100 is not limited to the two illustrated user devices 110 in FIG. 1. Insurance information network system 100 may comprise an unlimited number of user devices 110 operated by any number of various users. Further, it is contemplated that users may access network 106 from a multiple and a variety of different devices 110 and need not use the same device 110 each time user access insurance information system 101 via network 106.

Each user device 110 is preferably implemented by the use of one or more general purpose computers, such as, for example, a typical personal computer manufactured by Dell™, Gateway™, or Hewlett-Packard™. Those skilled in the art will understand that the user devices 110 may be a laptop computer, a personal digital assistant (PDA), a mobile phone, a set top box, an interactive television or the like.

The user devices 110 may include a microprocessor. The microprocessor can be any type of processor, such as, for example, any type of general-purpose microprocessor or microcontroller, a digital signal processing (DSP) processor, an application-specific integrated circuit (ASIC), a programmable read-only memory (PROM), or any combination thereof.

The user devices 110 can also include computer memory, such as, for example, random-access memory (RAM). However, the computer memory of user devices 110 can be any type of computer memory or any other type of electronic storage medium that is located either internally or externally to the user devices 110, such as, for example, read-only memory (ROM), compact disc read-only memory (CDROM), electro-optical memory, magneto-optical memory, erasable programmable read-only memory (EPROM), and electrically-erasable programmable read-only memory (EEPROM), or the like.

According to exemplary embodiments, the corresponding RAM can contain, for example, a web browser application for the user devices 110. The web browser application typically will communicate with the network 106 to allow a user operating a user device 110 to access and participate in an insurance information interface hosted by insurance information system 101.

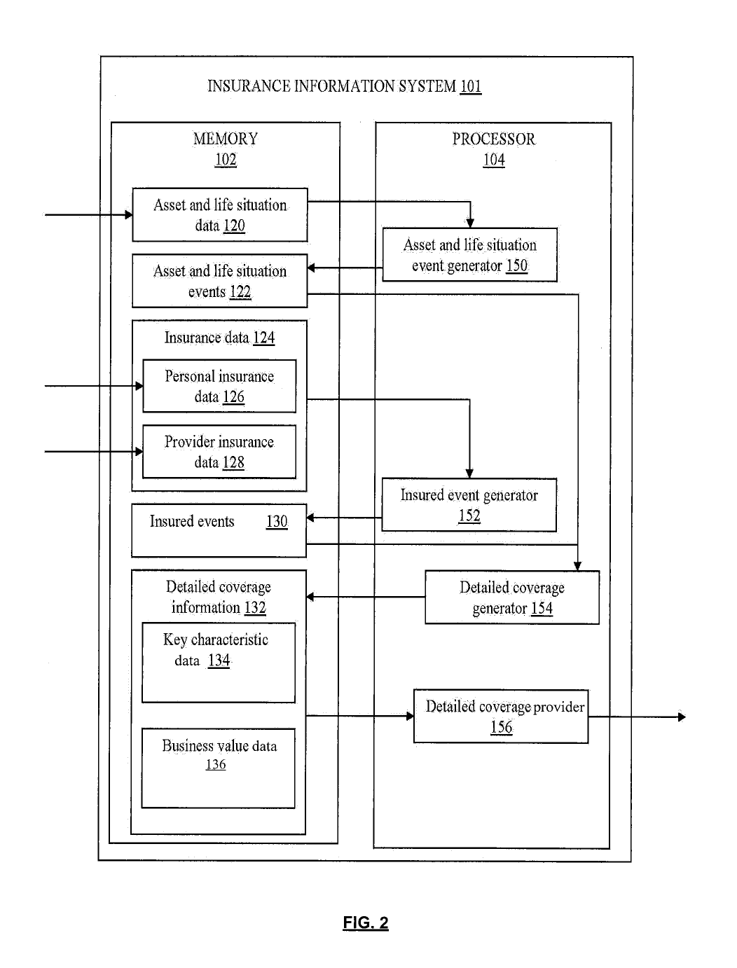

Insurance information system 101 hosts one or more insurance information interfaces. Insurance information system 101 typically includes a web server to receive and respond to network requests made by the web browser of user device 110. An exemplary insurance information system 101 will be described in greater detail in reference to FIG. 2.

The network 106 may be a local area network (LAN), a wide area network (WAN), the Internet, analog or digital wired and wireless telephone networks (e.g. a Public Switched Telephone Network (PSTN), an Integrated Services Digital Network (ISDN), or a Digital Subscriber Line (xDSL)), or any other wired or wireless network. The network 106 may include multiple networks or subnetworks, each of which may include, for example, a wired or wireless communications channel.

Reference is now made to FIG. 2, in which an exemplary embodiment of insurance information system 101 of insurance information network system 100 of FIG. 1 is illustrated. In the exemplary embodiment shown in FIG. 2, insurance information system 101 stores insurance related data in memory 102 and process insurance related data in processor 104.

Memory 102 may store asset and life situation data 120, asset and life situation events 122, insurance data 124, insured events 130, and detailed coverage information 132. Insurance data 124 may comprise at least one of personal insurance data 126 and provider insurance data 128. Detailed coverage information 132 may comprise at least one of key characteristic data 134 and business value data 136.

Processor 104 may have an asset and life situation event generator 150, an insured event generator 152, a detailed coverage generator 154, and a detailed coverage provider 156.

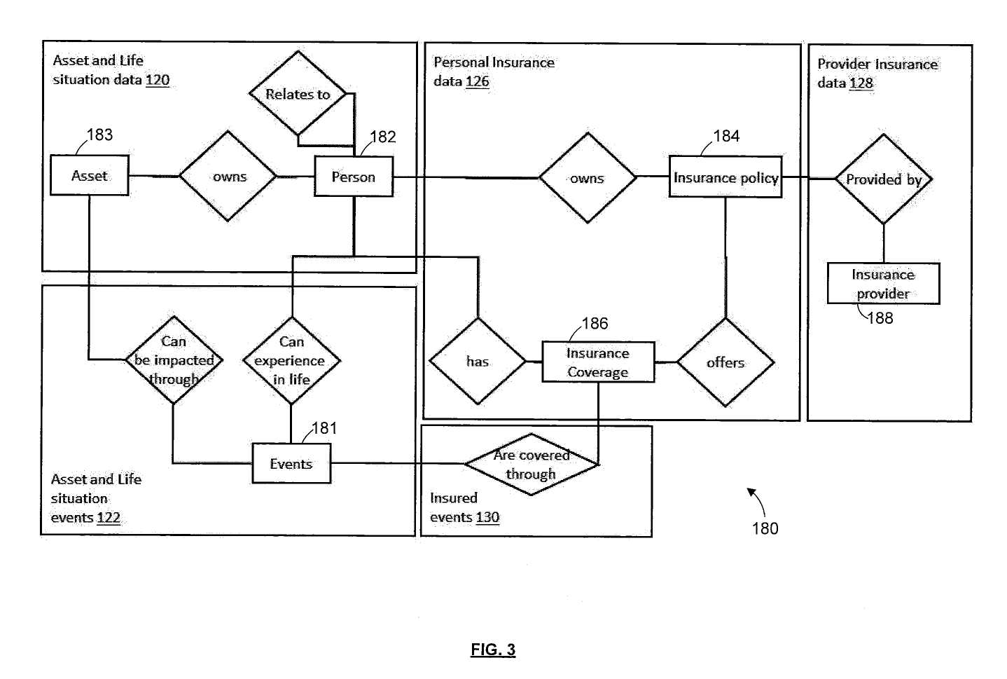

Reference is now made to FIG. 3, in which an exemplary embodiment of a database 180 of insurance information is illustrated. Database 180 may be in memory 102 of insurance information system of FIG. 2.

Asset and life situation data 120 comprises information relating to life situations of a person 182 and information about assets 183 owned by person 182. Asset and life situation events 122 comprise events 181 that person 182 can experience in life and can impact assets 183.

Insured events 130 comprise events 181 that are covered through coverage insurance 186. Personal insurance data 126 comprises an insurance policy 184 that is owned by person 182. Personal insurance data 126 further comprises insurance coverage 186 that person 182 has and that is offered under insurance policy 184.

Provider insurance data 128 comprises an insurance provider 188 that provides insurance policy 184.

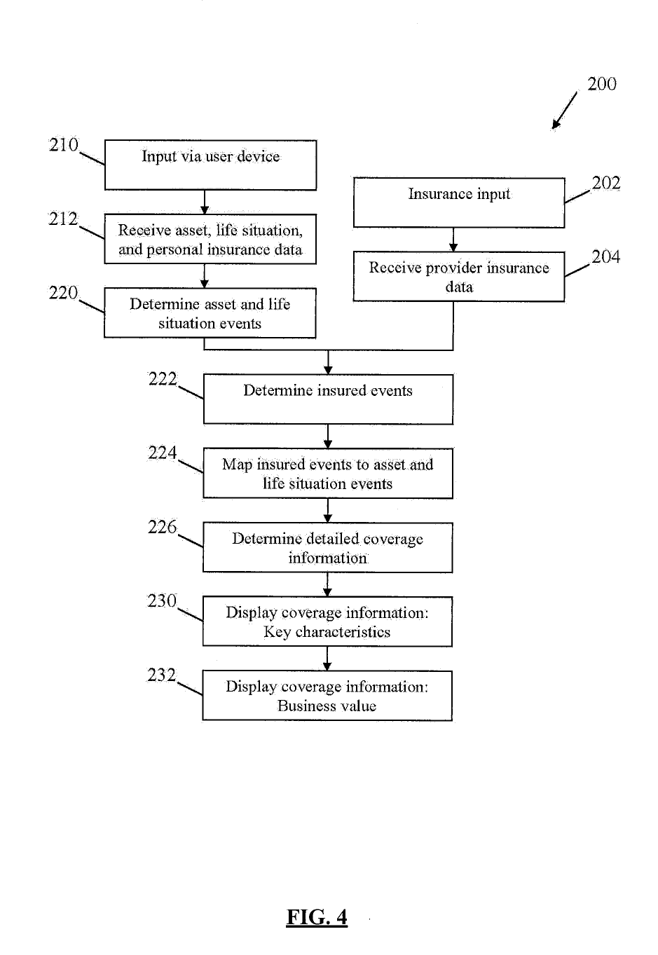

Reference is now made to FIG. 4, in which an exemplary embodiment of a method 200 for processing insurance information is illustrated.

At 210, a user enters asset and life situation data 120 and personal insurance data 126 into user device 110 via the insurance information interface. At 212, insurance information system 101 receives asset and life situation data 120 and personal insurance data 126. The received asset and life situation data 120 and personal insurance data 126 are stored in memory 102.

At 220, processor 104 determines asset and life situation events 122 based on the received asset and life situation data 120 using asset and life situation event generator 150. The determined asset and life situation events 122 are stored in memory 102.

At 202, provider insurance data 128 is input. In at least one embodiment, provider insurance data 128 comprises data obtained from at least one of a plurality of distinct insurance providers. At 204, insurance information system 101 receives provider insurance data 128. The received provider insurance data 128 is stored in memory 102.

At 222, processor 104 determines insured events 130 based on the received personal insurance data 126 and provider insurance data 128 using insured event generator 152. The determined insured events 130 are stored in memory 102.

At 224, processor 104 maps insured events 130 to asset and life situation events 122. At 226, processor 104 determines detailed coverage information 132 based on the mapped events 130, 122 using detailed coverage generator 154. The determined detailed coverage information 132 is stored in memory 102.

At 230 and 232, processor 104 provides detailed coverage information 132 using detailed coverage provider 156. For example, at 230, processor 104 provides key characteristic data 134 to user device 110 via network 106. For example, at 232, processor 104 provides business value data 136 to user device 110 via network 106.

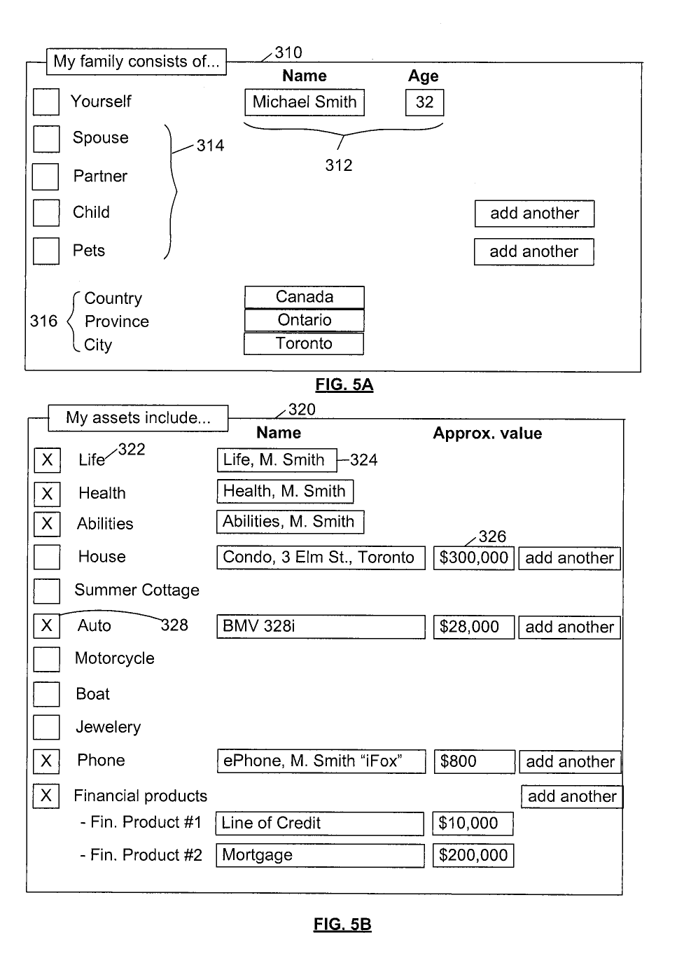

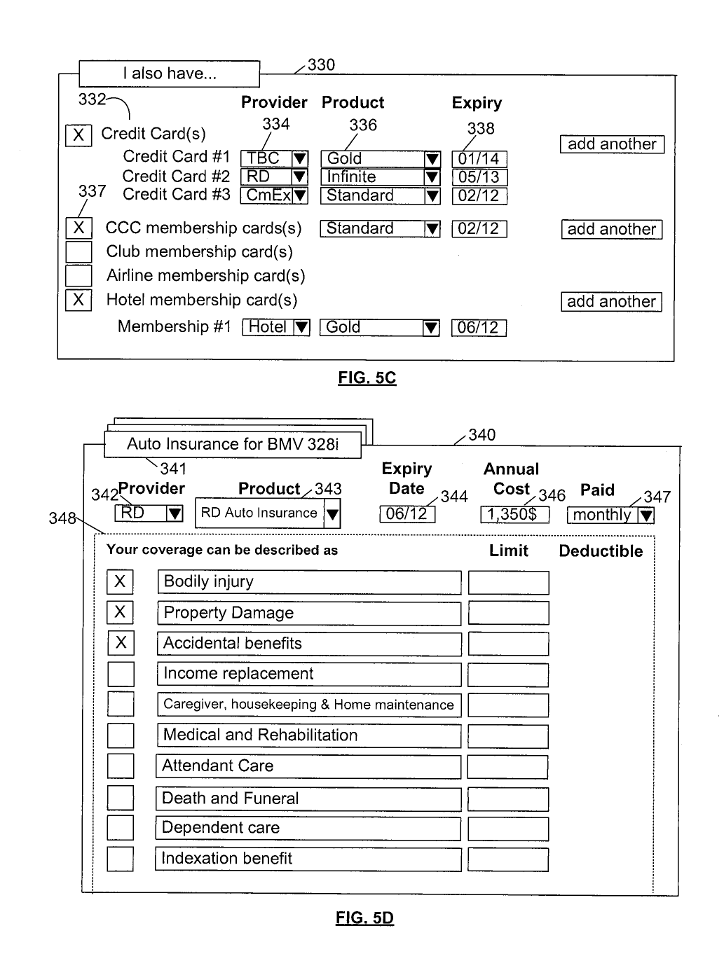

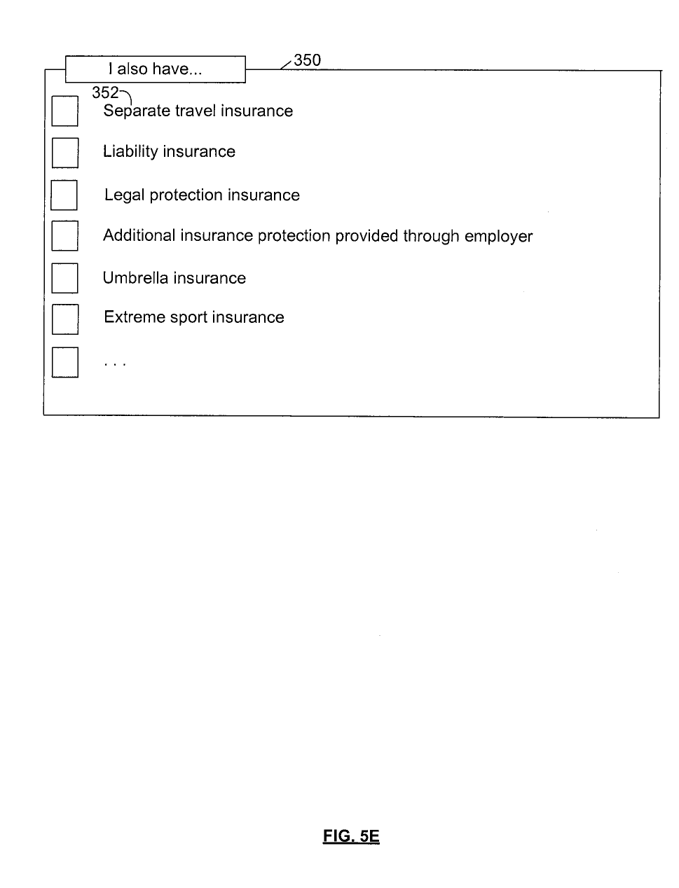

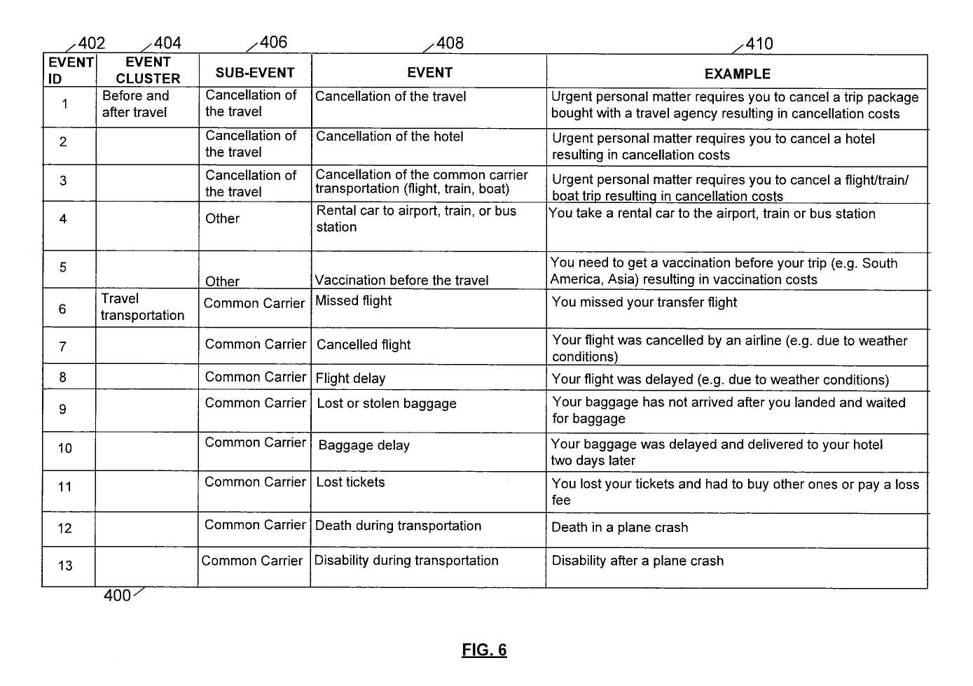

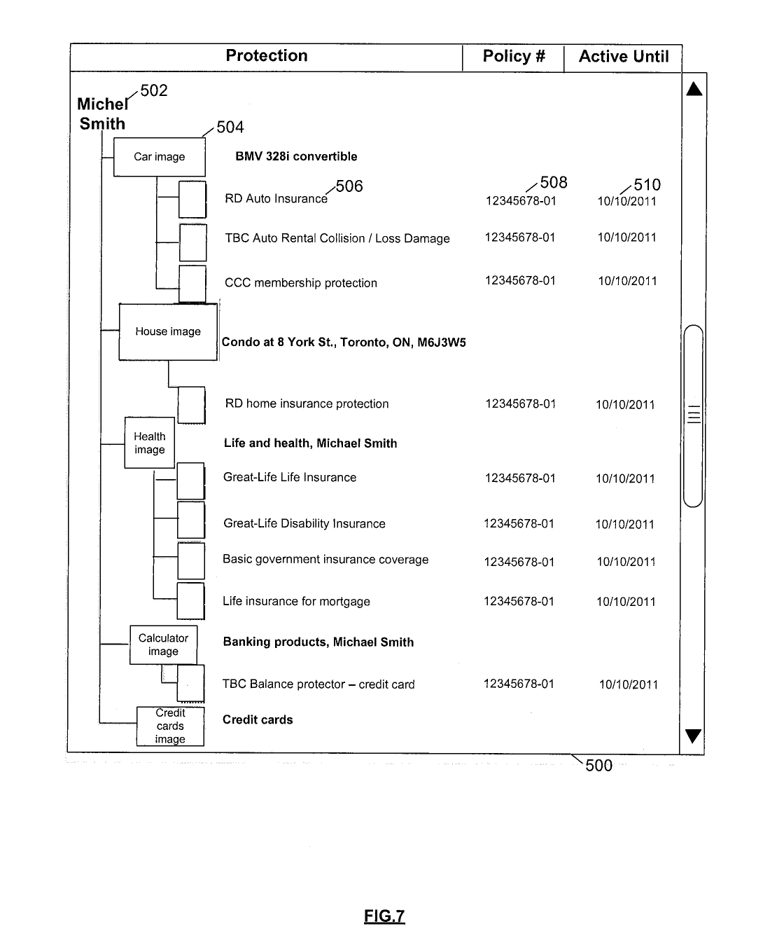

Reference is now made to FIGS. 5A, 5B, 5C, 5D, and 5E in which an exemplary embodiment of a method for receiving asset and life situation data 120 and personal insurance data 126 is illustrated. In at least one embodiment when asset and life situation data 120 and personal insurance data 126 are input via user device 110 they are transmitted via network 106 to insurance information system 101 and stored in memory 102.

In at least one embodiment, asset and life situation data 120 can be broken down into standard classes of single assets (e.g. property) and life situations (e.g. travel). In a further embodiment, asset and life situation data 120 comprise assets and life situations that are relevant to insurance.

FIG. 5A illustrates an exemplary personal detail user interface 310 for inputting life situation data 120 such as personal details via user device 110. Information input may comprise at least one of personal information 312, family information 314, and address details 316. For example, personal information 312 may include name and age details.

In at least one embodiment, a user will complete an initial registration upon first access to insurance information system 101. In at least one embodiment, a user may edit previously entered data, add to data, or delete data at any time.

FIG. 5B illustrates an exemplary asset detail user interface 320 for inputting asset situation data 120 such as asset details via user device 110. Information input may comprise at least one of an asset type 322, an asset name 324, an asset value 326, and an asset indicator 328. For example, asset type 322 may include life, health, abilities, house, summer cottage, automobile, motorcycle, boat, jewelry, phone, and various financial products. Asset name 324 may detail the specific name of the asset listed. Asset value 326 may comprise an actual or estimated monetary value of the asset listed. Asset indicator 328 may indicate whether the user owns the asset listed.

FIG. 5C illustrates an exemplary personal insurance detail user interface 330 for inputting personal insurance data 120 via user device 110. In at least one embodiment, personal insurance data includes membership card and credit card details. Information input may comprise at least one of a credit card or membership card type 332, a card/membership provider 334, a product name 336, a card/membership indicator 337, and a card/membership expiry date 338. Credit card or membership card type 332 may detail, for example, credit card, auto membership, airline membership, and hotel membership. Card/membership provider 334 may detail the company or organization which provides the service. Product name 336 may detail the specific policy or plan type of the credit card or membership card. Card/membership indicator 337 may indicate whether the user has the card/membership listed.

FIG. 5D illustrates an exemplary insurance coverage detail user interface 340 for inputting personal insurance data 120 such as coverage details for a specific asset 341 via user device 110. Specific asset 341 may be, for example, an asset indicated by asset indicator 328 in asset detail user interface 320 of FIG. 5B. Information input into insurance coverage detail user interface 340 may comprise at least one of an insurance provider name 342, an insurance product name 343, an insurance policy expiry date 344, an annual cost 346, and a period of payment 347.

Insurance provider name 342 may detail the company or organization which provides the insurance. Insurance product name 343 may detail the specific policy or plan type for the specific asset 341.

In at least one embodiment, user inputs provider insurance data 128. For example, insured asset detail user interface 340 may provide an input for provider insurance data 128 at 348.

FIG. 5E illustrates an exemplary additional personal insurance user interface 350 for inputting additional personal insurance data 120 such as coverage details for miscellaneous insurance protection 352 via user device 110. Miscellaneous insurance protection 352 may be, for example, separate travel insurance, liability insurance, legal protection insurance, employer insurance, umbrella insurance, and extreme sport insurance.

In at least one embodiment, when the user inputs data into the user interface, the information entered will be dynamically updated on the display of user device 110.

Processor 104, using asset and life situation event generator 150, breaks down the asset and life situation data 120 into asset and life situation events 122. Processor 104 determines asset and life situation events 122 based on the asset and life situation data 120 entered by the user. For example, some of the data entered in user interfaces 310, 320, 330, 340, 350 of FIGS. 4A, 4B, 4C, 4D, and 4E may be used by the asset and life situation event generator 150.

In a further embodiment, asset and life situation events 122 comprise a defined set of insurable events which impact assets and life situations. In at least one embodiment, asset and life situation events 122 comprise a holistic list of events for each asset and life situation. In a further embodiment, a subset of the holistic event list can be applied to all users.

In at least one embodiment, the holistic event list describes in simple language the insurable events which a user can face. In a further embodiment, the insured events 130 illustrate that it is not an asset that is protected through insurance but rather events are protected by insurance for the particular assets owned by the user and the life situations that the user encounters.

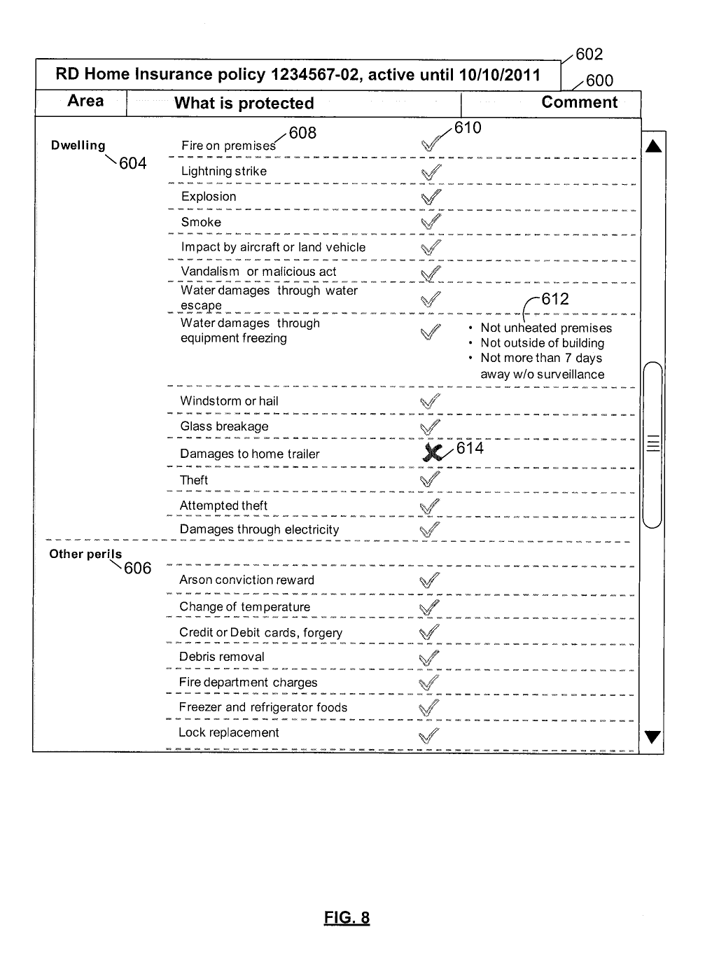

Reference is now made to FIG. 6, in which an exemplary embodiment of a database table 400 for life situation events 122 is illustrated. Database table 400 illustrates an exemplary list of holistic events. Database table 400 may comprise at least one of an event identifier 402, an event cluster 404, a sub-event 406, an event name 408, and an event example 410.

Event identifier 402 may use a unique number to reference a particular event 408. Event cluster 404 indicates a grouping of events 408 that the user may encounter while owning the asset or experiencing the life situation. Sub-event 406 further breaks down the grouping within event cluster 404 indicating similar events 408.

Event name 408 details the particular event that the user may encounter while owning the asset or experiencing the life situation. Event example 410 gives an example of what event 408 may comprise.

In at least one embodiment, any one or more of event identifier 402, event cluster 404, sub-event 406, event name 408, and event example 410 is provided to the user on user device 110.

In the exemplary embodiment of database 400, the asset and life situation data 120 entered indicates that the user may experience a travel life situation. For example, event cluster 404 may comprise “before and after travel”, where sub-event 406 may comprise “cancellation of the travel”, and where event name 408 may comprise “cancellation of the hotel”. For example and as indicated in the event example 410, a user may experience an urgent personal matter that requires the cancellation of a hotel resulting in cancellation costs.

Reference is now made to FIG. 7, in which an exemplary embodiment of a user interface display 500 of assets with associated personal insurance data 126 and provider insurance data 128 is illustrated. A user has entered asset and life situation data 120 and personal insurance data 126. Display 500 may comprise at least one of a user name 502, an asset name 504, an insurance policy name 506, an insurance policy number 508, and an insurance policy active until date 510.

In at least one embodiment, a user may select asset 504 that they are interested in and the insurance policy 506 that they would like more information about. Once selected, processor 104 may provide ensured events 130 to user via user device 110.

Processor 104, using insured events generator 152, breaks down the insurance data 124 into insured events 130. Processor 104 determines insured events 130 based on personal insurance data 126 and provider insurance data 128. In at least one embodiment, insurance policy 506 can be disaggregated into a subset of holistic insured events 130. In a further embodiment, insured events 130 may have different names from one insurance policy 506 to another but still offer insurance protection for the same event.

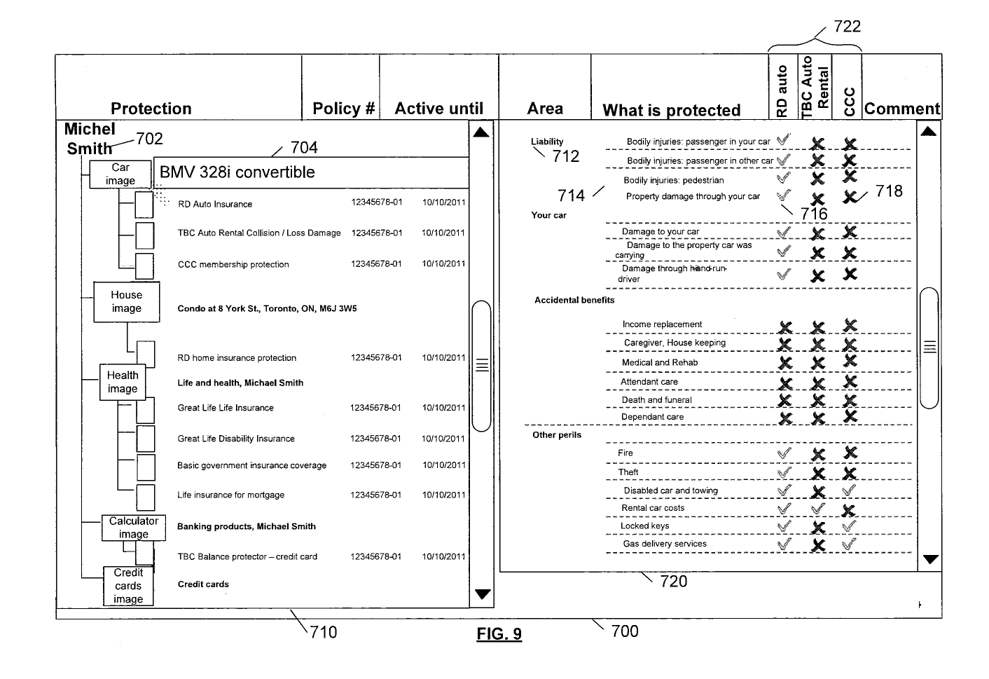

Reference is now made to FIG. 8, in which an exemplary embodiment of a user interface display 600 of insured events 130 is illustrated. Display 600 illustrates a user selected specific insurance policy 602 (for example, insurance policy 506 of FIG. 7). Display 600 illustrates insurance policy 602 broken down by processor 104 into insured events 608. Display 600 may comprise any one or more of an insured event 608, an insured indicator 610, 614, an insured event comment 612, and an insured event category 604, 606.

In at least one embodiment, insured indicator 610, 614 indicates to the user whether event 608 is covered by insurance policy 602. For example, insured indicator 610 indicates, in the exemplary embodiment of display 600, that insurance policy 602 provides insurance coverage for insured event 608 of “fire on premises” under insured event category 604 “dwelling”. For example, insured indicator 614 indicates, in the exemplary embodiment of display 600, that insurance policy 602 does not provide insurance coverage for insured event 608 of “damages to home trailer” under insured event category 604 “dwelling”.

Reference is now made to FIG. 9, in which an exemplary embodiment of a display 700 of detailed coverage information 132 is illustrated. A user has entered asset and life situation data 120 and personal insurance data 126. Display 700 may comprise at least one of a user name 702, an asset name 704, an insured event category 712, an insured event 714, an insured indicator 716, 718, and an insurance policy name 722.

In at least one embodiment, display area 710 may be the same display 500 of FIG. 7.

In at least one embodiment, a user may select asset 704 that they would like more information about. Once selected, processor 104 may provide ensured events 130 to user via user device 110. In a further embodiment, display area 720 illustrates the detailed coverage information 132 for selected asset 704.

Processor 104, using detailed coverage generator 154, maps the insured events 130 to the asset and life situation events 122. Display area 720 illustrates a user-selected asset 704. Display area 720 illustrates detailed coverage information 132 mapped by processor 104. Detailed coverage information 132 may comprise insured event category 712, insured event 714, insured indicator 716, 718, and insurance policy name 722.

In at least one embodiment, insured events 714 are listed across a plurality of different insurance policies 722 relevant for asset 704. Insured indicator 716, 718 indicates whether insured event 714 is provided (716) or not provided (718) under insurance policies 722. In at least one embodiment insured indicator 716, 718 further indicates whether insurance coverage is optionally available (not shown) for insured event 714.

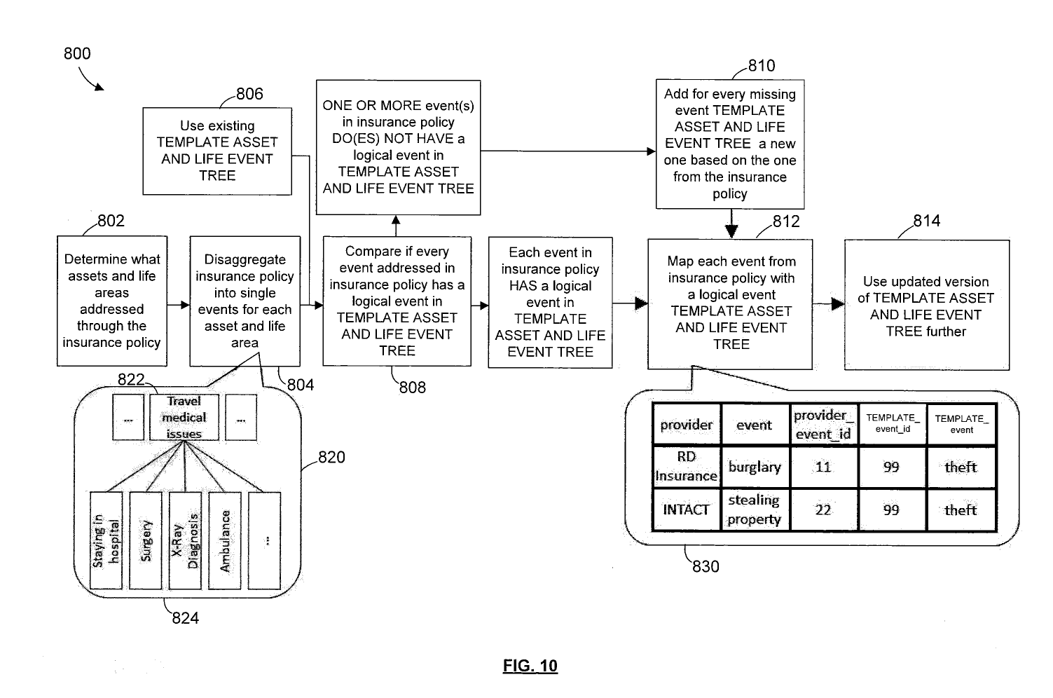

Reference is now made to FIG. 10, in which an exemplary embodiment of a flow chart of a method 800 for mapping insured events to asset and life situation events is illustrated. Method 800 may be performed by, for example, detailed coverage generator 154 of processor 104.

At 802, processor 104 determines what asset and life situations are mentioned in a particular insurance policy. Provider insurance data 128 may comprise the particular insurance policy. For example, insurance policy may cover auto, liability, and personal injuries or travel medical issues.

At 804, processor 104 disaggregates the insurance policy into single events for each asset and life situation. For example, a life situation area may be travel medical issues 822 that is disaggregated into single events such as, for example, surgery 824.

At 806, system 101 refers to a stored in memory 102 a template asset and life event tree. Template asset and life event tree comprises events that may be covered by insurance.

At 808, processor 104 compares if every event disaggregated from 804 has a corresponding event in the template asset and life event tree. Where a disaggregated event exists that is not in the template asset and life event tree, processor 104 creates a new event based on the missing one from the insurance policy at 810. In at least one embodiment the newly created event has a generalized description such that it can be used for the mapping of a different insurance policy.

At 812, processor 104 maps each event from the insurance policy with the template asset and life event tree. For example, the mapped events may comprise a table 830 that is stored in memory 102.

At 814, in a particular embodiment, processor 104 modifies the template asset and life event tree to include the event created at 810. In a further embodiment, processor 104 uses the updated template asset and life event tree in a next mapping of insured events to asset and life situation events.

Reference is now made to FIG. 11, in which an exemplary embodiment of a display 900 of life situation events is illustrated. Display 900 may comprise at least one of a user name 902, a life event category 904, an life event group 906, and an life situation event 908. In at least one embodiment, a user may select life situation event 908 that they would like more information about. Once selected, processor 104 may provide detailed coverage information 132 to the user via user device 110. Life situation event cover also all the events associated with assets.

In at least one embodiment, detailed coverage information 132 may be illustrated in display area 916. Display area 916 may comprise at least one of a selected asset and life situation event 910 (e.g. asset and life situation event 908 of display area 900), an insured indicator 912, and an insurance policy 914.

In at least one embodiment, detailed coverage information 132 may be provided for asset and life situation events 132 that have occurred or that may occur in the future. In a further embodiment, an indicator 918 may be used to indicate whether asset or life situation event 132 has occurred.

In a further embodiment, all data stored in memory 102 may be searchable by a user (e.g. by using a keyword search 920).

Reference is now made to FIG. 12, in which an exemplary embodiment of a display 1000 of detailed coverage information 132 is illustrated. Display 1000 may comprise at least one of a user name 1002, an life situation type 1004, an life situation category 1006, and a life situation event 1008.

In at least one embodiment, a user may select the life situation 1006 that they would like more information about. Once selected, processor 104 may provide detailed coverage information 132 to user via user device 110.

In at least one embodiment, detailed coverage information 132 may be illustrated in display area 1016. Display area 1016 may comprise at least one of a selected life situation event 1010 (e.g. life situation events 1008 of display area 1000), an insured indicator 1012, and an insurance policy 1014.

In at least one embodiment, the user may select life situation event 1010, which triggers a display 1020. In a further embodiment, the user selects insured indicator 1012 to trigger display 1020. Display area 1020 may comprise detailed coverage information 132, which comprises key characteristic data 134. Key characteristic data 134 may comprise at least one of coverage availability 1022, a covered value 1024, a coverage condition 1026, a coverage price 1028, and a coverage name 1030.

Coverage availability 1022 may comprise yes (provided), optional (optionally provided), or no (not provided). Covered value 1024 may comprise the value of the coverage (e.g. maximum amount covered) under insurance policy 1014. Coverage condition 1026 may comprise the conditions for insurance coverage under insurance policy 1014. Coverage price 1028 may comprise the cost per time period (e.g. cost per month) of insured event 1010. Coverage name 1030 may comprise the authentic name of the insurance policy section for insured event 1010 under insurance policy 1014.

In at least one embodiment, detailed coverage information 132 comprises business value data 136, which comprises at least one of a coverage overview, comparison information, coverage overlap information, coverage gap information, coverage terms information, coverage payment information, and coverage recommendation information.

In at least one embodiment, business value data 136 provides transparency across existing insurance protection. System 101 may compare the coverage of policies from multiple providers. System 101 may identify protection overlaps. System 101 may identify protection gaps. System 101 may identify excessive or insufficient protection and recommend the right coverage level aligned with the individual's particular life and asset situation.

In at least one embodiment, system 101 eliminates the need for a user to go through their policies and look for potential protection. This results in a significant reduction of time for insurance management.

In at least one embodiment, a user can view coverage gap information from the detailed coverage information 132 where, for example, insured indicator 1012 indicates that there is no provided coverage for that insured event 1010. In at least one embodiment, comparison of coverage occurs on an event-by-event basis. In a further embodiment, system 101 may highlight the product with more extensive coverage. This may result in individuals getting a higher value for their costs. In a further embodiment, this results in individuals getting information to make a conscious decision about insurance cost savings. For example, a user may select a change in coverage for a less expensive product with a lower protection span. Users are able to see what coverage they have and assess whether they need such coverage.

In at least one embodiment, a user can view coverage terms information from the detailed coverage information 132 by selecting insured indicator 912.

Reference is now made to FIG. 12, in which an exemplary embodiment of coverage payment information 1100 is illustrated. Coverage payment information 1100 may comprise a detailed breakdown 1120 of payment information for at least one of a user name 1102, an asset name 1104, and an insurance policy name 1106. In at least one embodiment, coverage payment information 1100 may be broken down into any time period (e.g. month). In at least one embodiment, coverage payment information 1100 may be graphically illustrated (e.g. at 1110).

Reference is now made to FIG. 13, in which an exemplary embodiment of coverage overlap information 1200 is illustrated. Coverage overlap information 1200 may comprise a detailed breakdown 1210 of redundant insurance coverage for asset and life situation events 122. Coverage overlap information 1200 may comprise at least one of a protection overlap indicator 1202, a potential savings indicator 1204, 1206, and overlap details 1220.

In at least one embodiment, users are provided with details as to what insurance protection can be eliminated, thus reducing costs. User's decisions can be informed by comparison of values of coverage.

Protection overlap indicator 1202 may further comprise the names of the insurance policies that are overlapping. Potential savings indicator 1204 may comprise the monetary value of savings that could be achieved where insurance redundancies are removed. Potential savings indicator 1206 may comprise an indication that there exists an indirect overlap in insurance coverage.

In at least one embodiment, overlap details 1220 may comprise a policy name 1222, an insured event 1224, a potential savings value 1226, an insured indicator 1228, and a more details option 1230 for the insurance policies that are overlapping.

In at least one embodiment, protection gaps may be identified. In certain situations gaps can result in costs by not having events insured. Identification of these gaps and recommendations by system 101 may result in significant savings of non-insured costs in case of an accident.

In at least one embodiment, detailed coverage information 132 may comprise protection recommendations. A user inputs certain personal details into system 101. For example, system 101 receives customer data such as marital status and children information. In this case, system 101 may highlight excessive insurance protection and provide the user with reduced insurance costs or identify insufficient protection and prevent cost-intensive accidents.

For example, if a user inputs information that they have a spouse and one child, system 101 can estimate the level of total life insurance required. System 101 can then compare the required life insurance level with the actual life insurance level to recommend to the user a reduction in excessive protection or an increase in insufficient protection. The user may then optionally alter the insurance protection, which may result in better protection/a cost savings.

In at least one embodiment, detailed coverage information 132 may comprise at least one of an insurance calendar and insurance tasks.

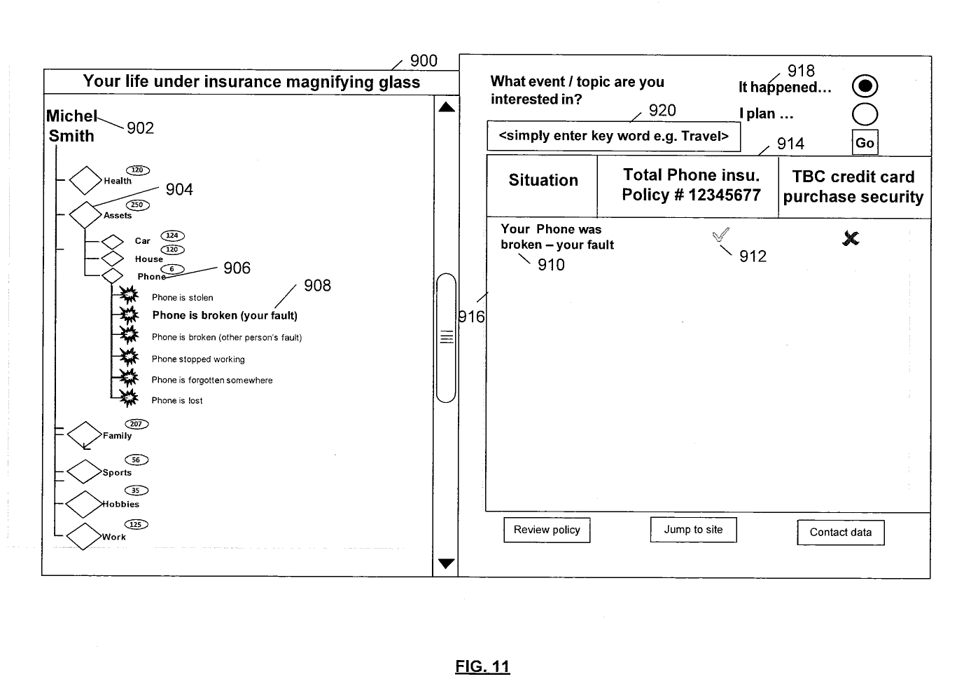

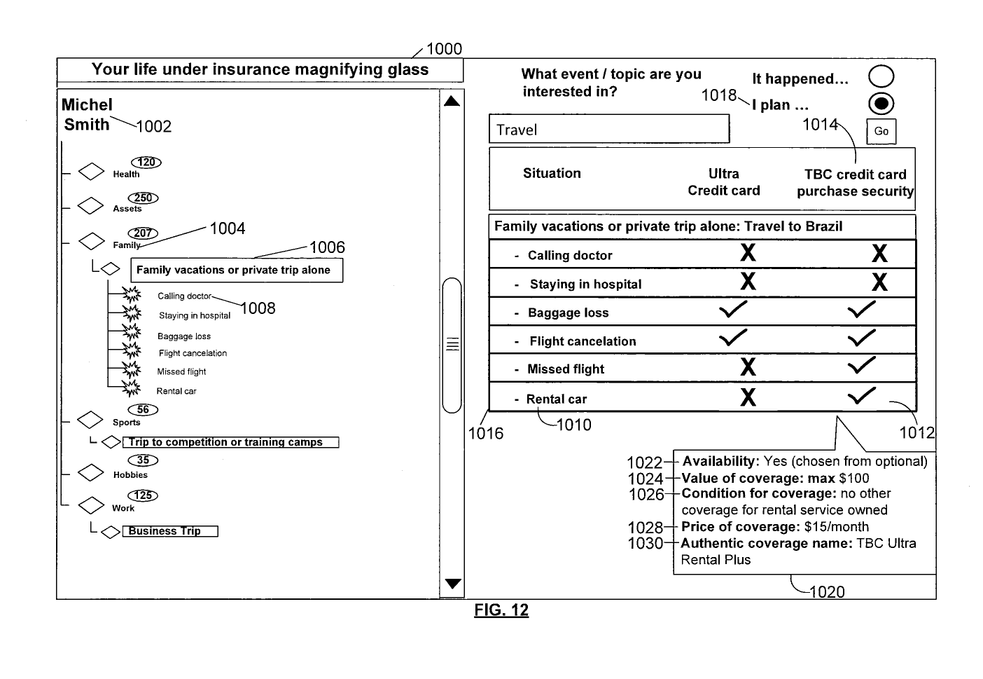

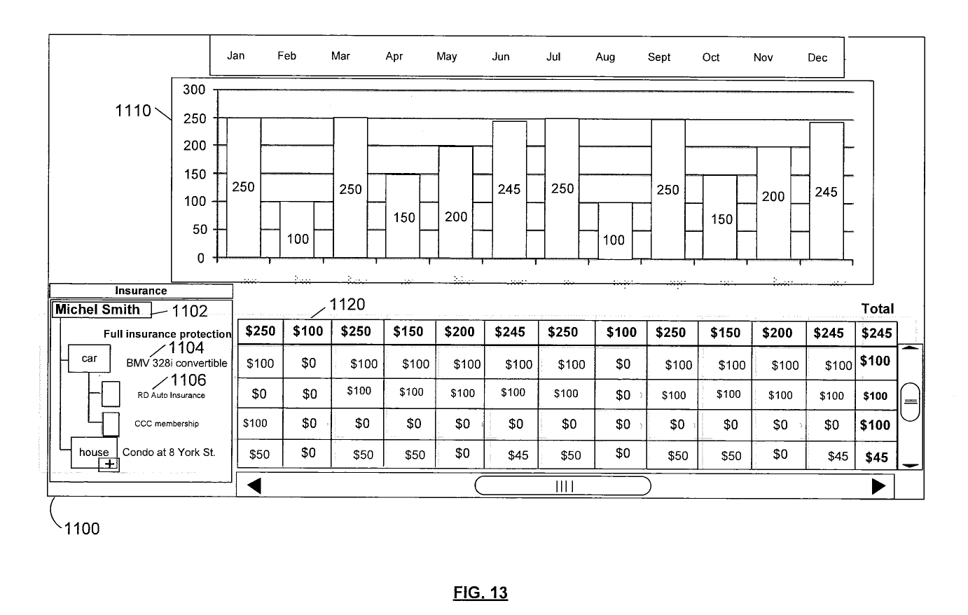

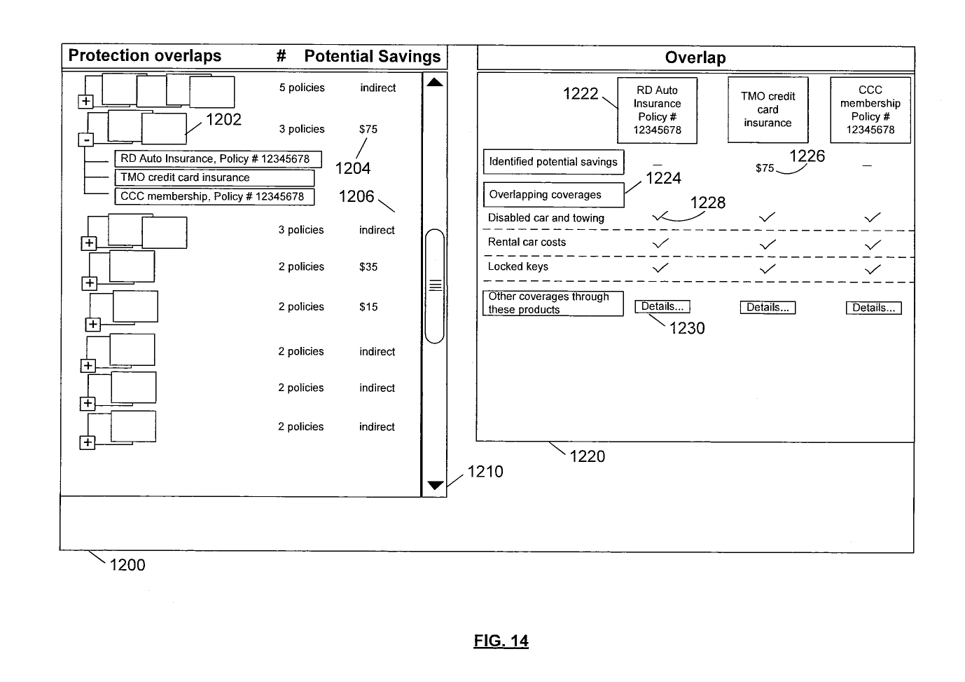

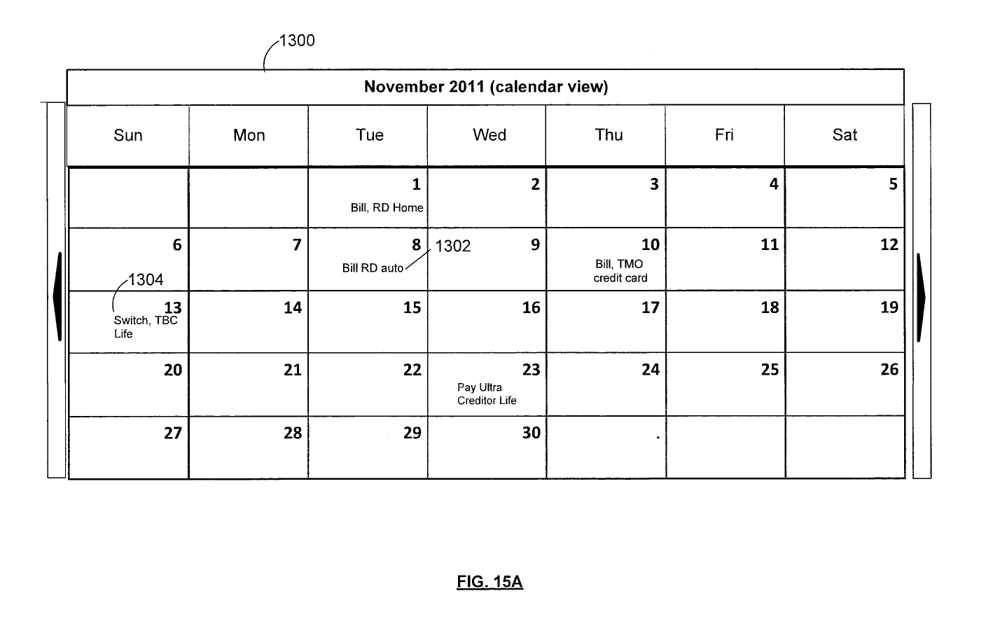

Reference is now made to FIG. 14A, in which an exemplary embodiment of an insurance calendar 1300 is illustrated. In at least one embodiment, insurance calendar 1300 may comprise at least one of an outstanding insurance payments/bills indicator 1302, last opportunities to change coverage indicator 1304, and another important topics indicator (not shown).

Reference is now made to FIG. 14B, in which an exemplary embodiment of insurance tasks 1310 is illustrated. In at least one embodiment, insurance tasks 1310 may comprise at least one of a task date 1312, a task name 1314, a monetary amount associated with each task 1316, and task details 1318.

In at least one embodiment, insurance information system 101 further comprises an insurance glossary. The insurance glossary provides a user with a searchable database of insurance terms with comprehensive definitions.

In at least one embodiment, insurance information system 101 further comprises an insurance tips display. The insurance tips display provides a user with a searchable database of insurance tips with comprehensive tips. In a further embodiment, the comprehensive tips may include details concerning insurance laws and regulations for a variety of geographic locations.

In at least one embodiment, insurance information system 101 provides detailed insurance information 132 to any user. In at least one alternative embodiment, insurance information system 101 provides an individual's detailed insurance information 132 only to authorized users.

In a further embodiment, third party users may access detailed insurance information 132 for a customer via a third party user interface. A third party user may comprise at least one of a broker, an agent, and an insurance provider.

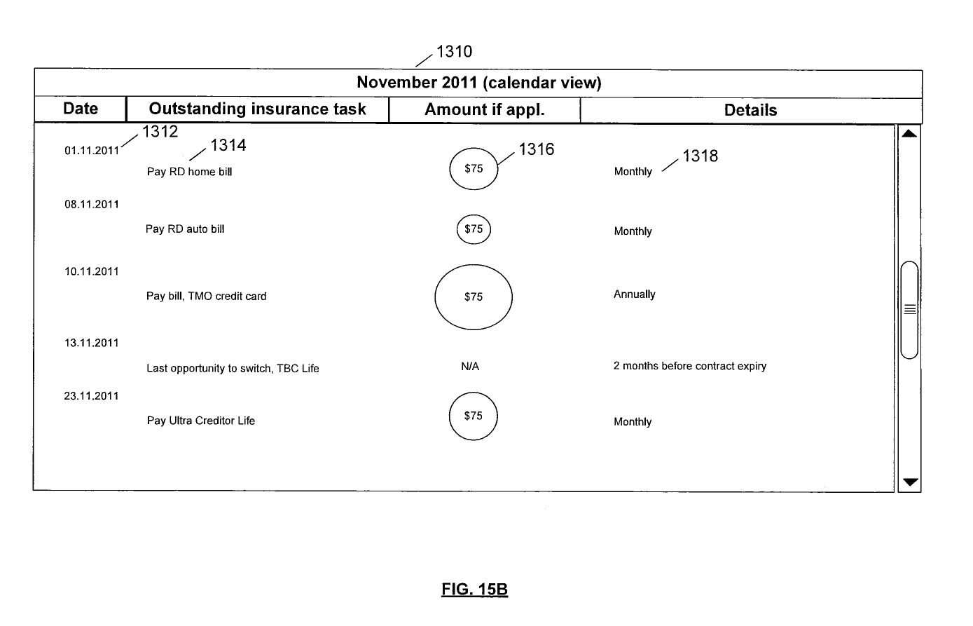

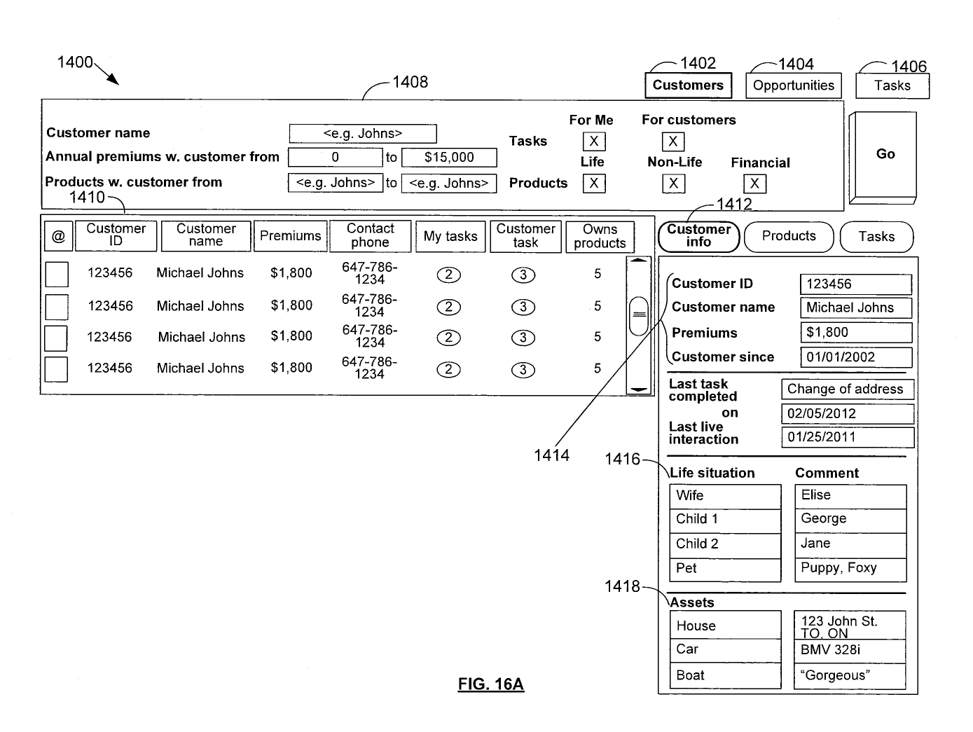

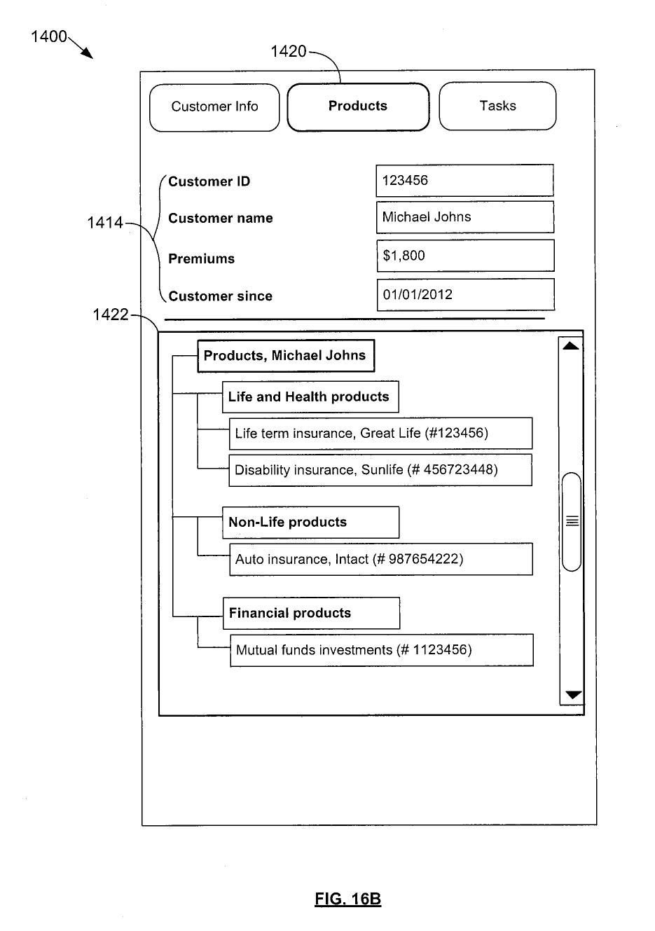

Reference is now made to FIGS. 15A and 15B, in which an exemplary embodiment of a third party detailed overview 1400 of a third party user interface is illustrated. Third party detailed overview 1400 may comprise a selection from among at least one of a customer data view 1402, a business opportunity data view 1404, and a task data view 1406.

In at least one embodiment, a third party user may search for detailed coverage information 132 using searching tools 1408. In at least one embodiment, third party detailed overview 1400 comprises a results list 1410. Results list 1410 may comprise any one of a customer identifier, a customer name, a premium amount, a contact phone number, third party tasks for that customer, customer tasks for that customer, and products owned.

In at least one embodiment, third party overview 1400 comprises customer personal information 1412. Customer personal information 1412 may comprise at least one of customer details 1414, and asset and life situation data 1418, 1416.

In at least one embodiment, third party overview 1400 comprises customer product information 1420. Customer product information 1420 may comprise at least one of customer details 1414 and insurance policies 1422.

In at least one embodiment, third party overview 1400 comprises customer task information. Customer task information may comprise at least one of outstanding tasks for the third party user and outstanding tasks for the customer.

In at least one embodiment, third party overview 1400 comprises business opportunities. Business opportunities may comprise at least one of a detailed list of insurance providing opportunities for a variety of customers across a variety of insurance product types.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A system for processing insurance information, the system comprising:
a memory for storing asset and life situation data, life events data, and insurance data; and
a processor coupled to the memory and configured for:
determining asset and life situation events based on the asset and life situation data;
determining insured events based on the insurance data;
determining detailed coverage information by mapping the insured events to the asset and life situation events; and
providing the detailed coverage information.

2. The system of claim 1, wherein the insurance data comprises personal and provider insurance data.

3. The system of claim 2, wherein the provider insurance data comprises data obtained from a plurality of distinct insurance providers.

4. The system of claim 3, wherein the processor receives asset, life situation, events, and personal insurance data from a user input device.

5. The system of claim 4, wherein the detailed coverage information is provided to a user device.

6. The system of claim 5, wherein the detailed coverage information comprises at least one of covered value, coverage condition, coverage price, and coverage name.

7. The system of claim 6, wherein the detailed coverage information further comprises at least one of: coverage overview, comparison information, coverage overlap information, coverage gap information, coverage terms information, coverage payment information, and coverage recommendation information.

8. The system of claim 7, wherein the processor is further configured for providing third parties a detailed overview of at least one of customer's assets, life situation, and insurance protection, and coverage.

9. The system of claim 8, wherein the third parties comprise at least one of brokers, agents, and insurance providers.

10. A method for processing insurance information, the method comprising:
storing asset and life situation data, life events data, and insurance data in a memory;
determining asset and life situation events based on the asset and life situation data using an at least one processor coupled to the memory;
determining insured events based on the insurance data using the at least one processor;
determining detailed coverage information by mapping the insured events to the asset and life situation events using the at least one processor; and
providing the detailed coverage information.

11. The method of claim 10, wherein the insurance data comprises personal and provider insurance data.

12. The method of claim 11, wherein the provider insurance data comprises data obtained from a plurality of distinct insurance providers.

13. The method of claim 12, wherein the method further comprises receiving asset, life situation, events, and personal insurance data from a user input device.

14. The method of claim 13, wherein the detailed coverage information is provided to a user device.

15. The method of claim 14, wherein the detailed coverage information comprises at least one of covered value, coverage condition, coverage price, and coverage name.

16. The method of claim 15, wherein the detailed coverage information further comprises at least one of: coverage overview, comparison information, coverage overlap information, coverage gap information, coverage terms information, coverage payment information, and coverage recommendation information.

17. The method of claim 16, wherein the method further comprises providing third parties a detailed overview of at least one of customer's assets, life situation, and insurance protection, and coverage.

18. The method of claim 17, wherein third parties comprise at least one of brokers, agents, and insurance providers

19. A physical non-transitory computer-readable medium upon which a plurality of instructions is stored, the instructions for performing the steps of the method as claimed in claim 10.
